(19) United States
(12) Patent Application Publication
(10) Pub. No.: US 2013/0097492 A1
(43) Pub. Date: Apr. 18, 2013

(54) Method of Providing English or Bilingual Legal Documents to Internet Users Who Lack Sufficient English Language Skills

(71) Applicant: Jennifer Yang, Palo Alto, CA (US)

(72) Inventor: Jennifer Yang, Palo Alto, CA (US)

(21) Appl. No.: 13/275,003

(22) Filed: Oct. 17, 2011

(51) Int. Cl. G06F 17/20

(52) U.S. Cl. 715/264

(57) ABSTRACT

A method or system of providing online legal document services to users lacking sufficient English language skills is provided, whereby an user accesses a legal services website written in a language understandable by the user, chooses the legal document(s) to be prepared, and fills in the corresponding questionnaire(s) written in that language, and the legal services provider accordingly creates the requested legal document(s) in English, or both in English and in that language, based on information retrieved from the user-answered questionnaire(s).

### TECHNICAL FIELD

The present invention relates to a method or system of providing online legal document preparation services to users lacking English language skills, for example, Chinese speakers who feel less comfortable reading and/or writing English.

### BACKGROUND OF THE INVENTION

Traditionally, a client who is interested in obtaining legal services seeks the assistance of legal professionals such as lawyers. This process can be both time-consuming and expensive. In recent years, self-assistance websites such as legalzoom.com and uslegal.com have filled the market demand for clients who are looking for an efficient and less expensive alternative to the traditional legal services providers. These online legal services providers typically create and file a legal document, i.e., a will or living trust, an immigration filing, a small claims filing, or a trademark registration, for the client after determining an individual client's special needs and preferences. These online legal document services are often offered for a fraction of the cost traditionally charged by legal professionals and thereby bridge the gap between the poor and legal assistance.

However, existing online legal services providers have so far neglected the need of people who have an inadequate command of the English language. Because many legal documents need to be prepared in English to be properly filed in this country, these people, unable to read or understand the English-only contents of the websites of existing online legal services providers, are forced to resort to the services of traditional lawyer firms or law offices, which may be unnecessarily time-consuming and more expensive. Accordingly, there is a market demand for a method or system that provides efficient and affordable online legal document provision services to clients lacking English language skills. Such a method or system shall allow a client to read and understand the contents of a legal services provision website written in a language preferred by the client, create a legal document(s) chosen and ordered by the client, and provide the client a copy of such document(s) written in English and optionally another copy written in the client-preferred language.

### SUMMARY OF THE INVENTION

It is an object of the present invention to provide a method or system for assisting users who do not have a strong command of the English language to gain access to online legal document services. According to the present invention, the object above is achieved through an automated online system whereby an appropriate legal document is created in English, or is created in two copies, one in English and the other in the user's preferred language, by the system based on information provided by the user through an online questionnaire written in the user's preferred language.

A typical embodiment of the present invention works in the following way. A user electronically connects to the online legal document services provider's website displayed in the user's preferred language and selects the subject matter that he or she is interested in. The website then prompts the user to complete an online questionnaire. Upon electronic submission of the questionnaire, the user-provided information is retrieved by the online legal document services provider and translated into English whereby necessary. The online legal document services provider then identifies the relevant non-customized legal document(s), which is pre-prepared and stored in a database, and used the translated information retrieved from the questionnaire, to fill in certain fields left blank in the non-customized legal document(s). The customization process may involve direct migration of data if a simple legal document is to be prepared, or may involve data analysis if a more complicated legal document is to be prepared. Upon completion of the customization process, the completed legal document(s) is either electronically delivered to the user or made available for the user to download from the website.

### BRIEF DESCRIPTION OF THE DRAWINGS

FIG. 1 is a comprehensive flowchart depicting the document provision process according to the present invention.

FIG. 2 is a flowchart depicting the process for the creation and maintenance of a questionnaire database by an online legal document services provider.

FIG. 3 is an example of an online questionnaire presented to and answered by a Chinese-speaking user wishing to have his will drafted.

FIG. 4 is the English translation of FIG. 3.

FIG. 5 depicts an example of a customized will created according to the present invention, using information retrieved from the completed questionnaire depicted in FIG. 3.

FIG. 6 is the Chinese translation of FIG. 5.

### DETAILED DESCRIPTION OF THE INVENTION

The present invention is now described with reference to the drawings, wherein like reference numerals are used to refer to like elements throughout. In the following description, for purposes of explanation, simplified Chinese is used as an example of the client preferred non-English language and a will is the legal document to be created according to the present invention. It is evident to one skilled in the art that the present invention may be practiced in any non-English language and is capable of providing many different types of legal documents including but not limited to a will as illustrated in the following.

As used in this application, the term “user” refers to a person, a party, or a business entity interested in obtaining online legal document services in accordance with the present invention. The term “provider” refers to an online legal document services provider who operates in accordance with the present invention. A provider may provide such services in one or multiple non-English languages. The term “server” refers to a computer-related entity, either a computer, a computer server, or a group of linked computers or computer servers. The term “legal staff” refers to a provider's inside employees composed of lawyers and paralegals, while the term “IT staff” refers to a provider's information technology employees composed of electrical engineering or computer science engineers who design and maintain the provider's host website, databases, and server(s).

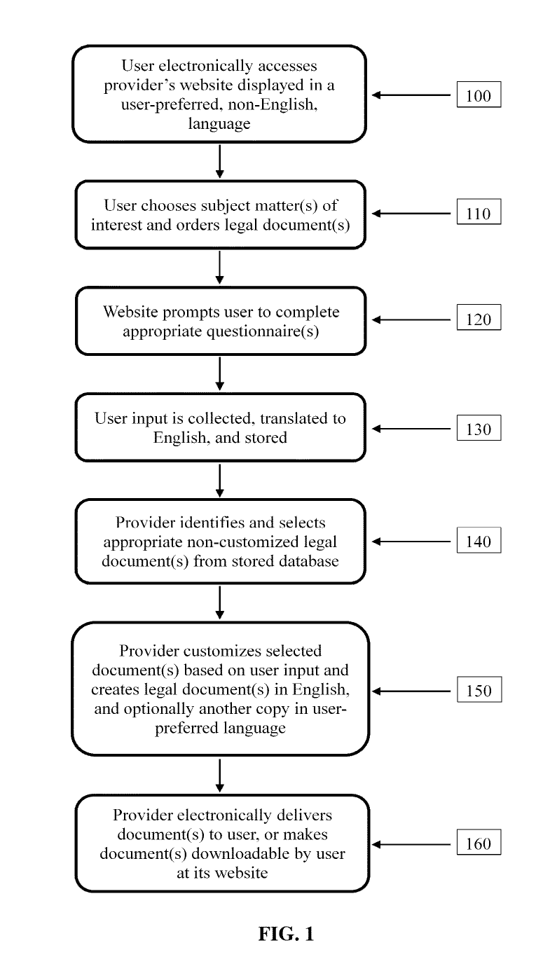

FIG. 1 illustrates a legal document provision process consistent with the present invention. A user electronically accesses a provider's host website via a desktop computer, laptop computer, tablet computer or mobile device such as a smart phone, whereas the website displays, or is capable of displaying, its contents in a non-English language that is understandable and preferred by the user 100. The user chooses one or multiple documents that he/she is interested in 110. The web portal then prompts the user to complete one or multiple questionnaires accordingly 120. During this step, the user is allowed to edit and confirm the accuracy of his/her answers. Once the user completes the questionnaire(s) and submits his/her complete answers, the user input is electronically submitted to and stored by a server of the provider 130. Upon retrieval of the user input, the provider, using its own legal staff or outside translation services, translates the user input to English.

In a preferred embodiment of the present invention, the legal staff of a provider includes at least one bilingual lawyer or paralegal for each non-English language in which the provider offers legal document services. “Bilingual lawyer or paralegal” herein means one with proficient language skills of English and one non-English language for the purposes of creating English legal documents for a client who lacks a strong command of English but reads and writes well in the non-English language. A provider may prefer to use its bilingual lawyer(s) or paralegal(s), instead of outside translation services, to translate a user's input, because this mode of operation will improve efficiency and reduce cost.

After processing the user input, the provider's legal staff, based on the legal document(s) the user orders 110 and the stored-and-translated user input 130, identifies the appropriate legal document(s) pre-stored in a database 140. In the next step, the legal staff customizes the document(s) using information retrieved from the user input and creates one copy of finished legal document(s) in English, and optionally another copy in the user-preferred language 150. The customization process may involve direct migration of data if simple legal document(s) are to be prepared—that is to fill in certain fields left blank in the non-customized document(s). However, if complicated legal document(s) are to be prepared, the legal staff may have to perform data analysis to find or deduce relevant information from the user's answers to the questionnaire.

As a final step, the customized legal document(s) are electronically delivered to the user through email or made available for download by the user at the provider's website 160. Depending on the user's preference indicated in his/her answers to the questionnaire, an English copy, or both an English copy and a copy in the user-preferred language, will be delivered or made downloadable. Alternatively, the customized legal document(s) may be printed and delivered through a mail service.

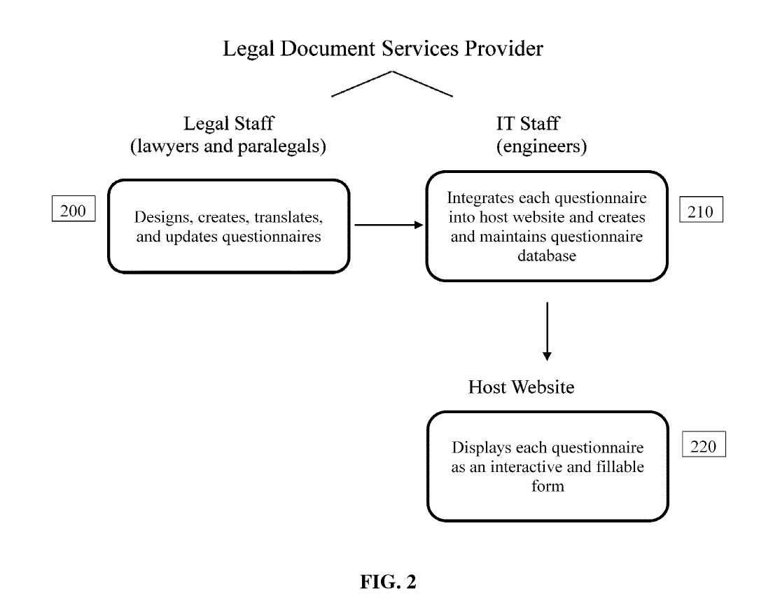

FIG. 2 illustrates a process or method of creating and maintaining a non-customized legal documents database consistent with the present invention. The legal staff of a provider designs and creates a different questionnaire for each different legal document included in the provider's product list 200. Each questionnaire is designed in such a manner that the full contents of the questionnaire combined with the answers that it solicits will furnish sufficient and accurate information to create a legal document consistent with the requirements of the current law. Each questionnaire is translated into one or multiple non-English language(s) by the legal staff or outside translation services, if it is originally written in English. Alternatively, in accordance with the preferred embodiment of the present invention, bilingual staff member(s) of the legal staff design and write each questionnaire in a non-English language. Next, IT staff of the provider adapts each questionnaire into the host website as an interactive and fillable HTML form 220, creates a questionnaire database, and stores the database on a server 210.

To reflect constant change in the law, the legal staff needs to periodically update the content of each questionnaire 200, and the IT staff will subsequently update the questionnaire database 210.

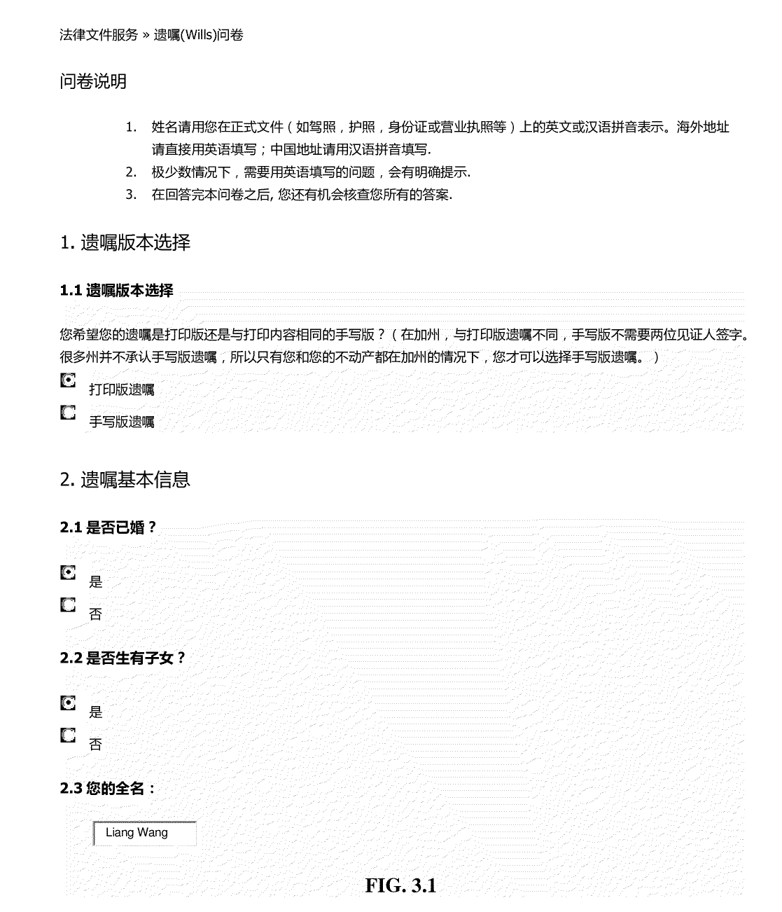

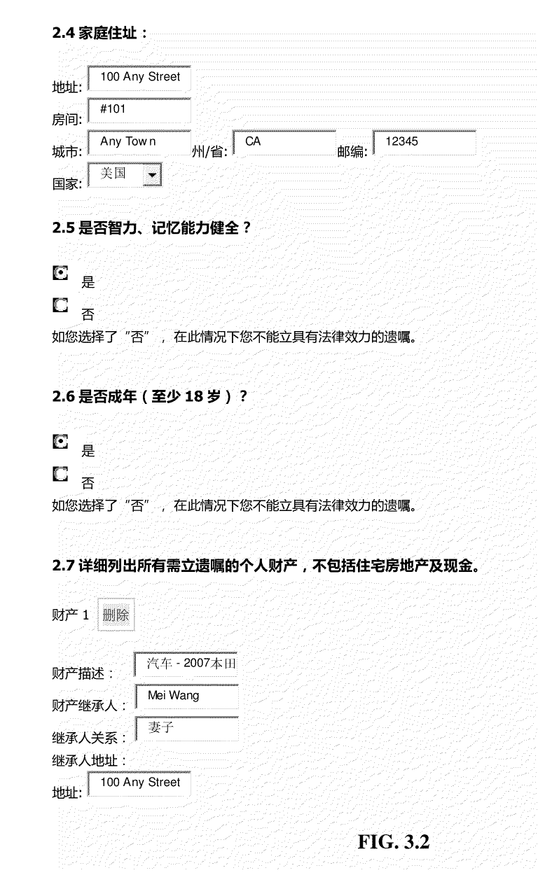

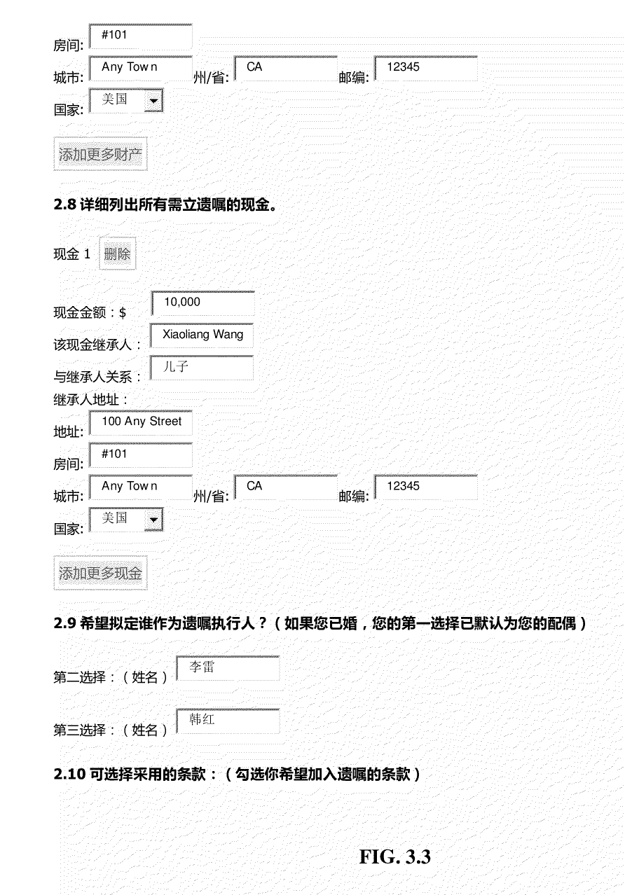

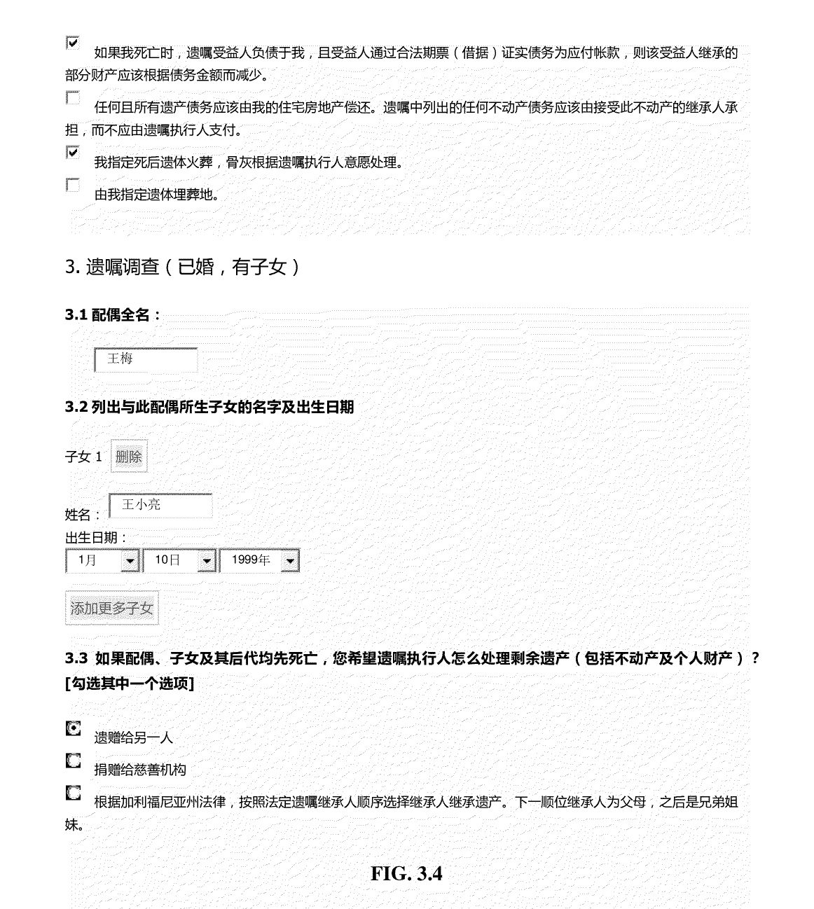

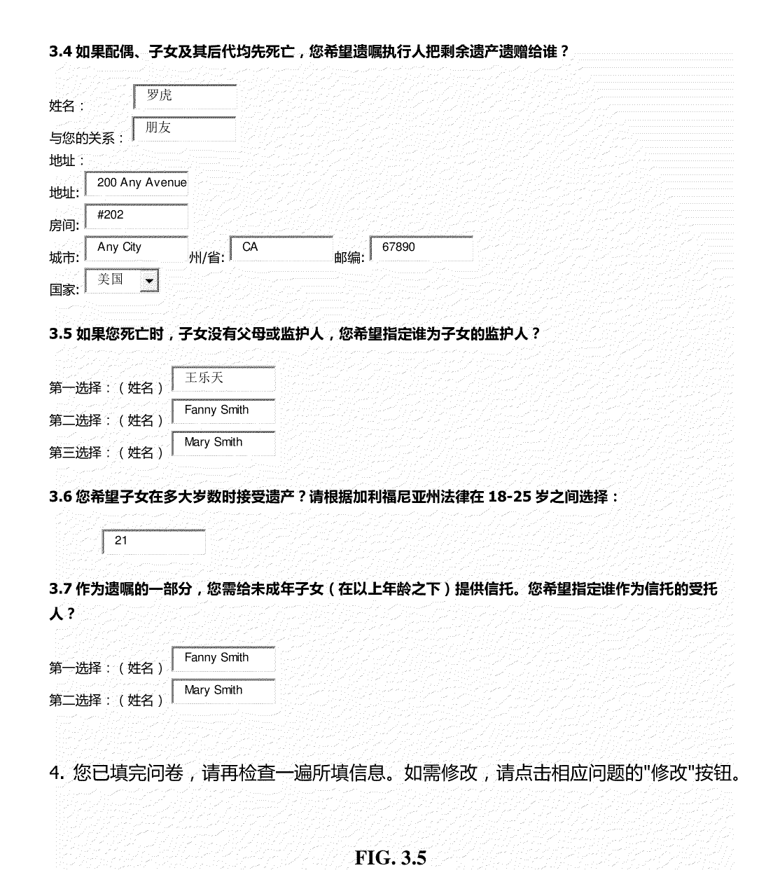

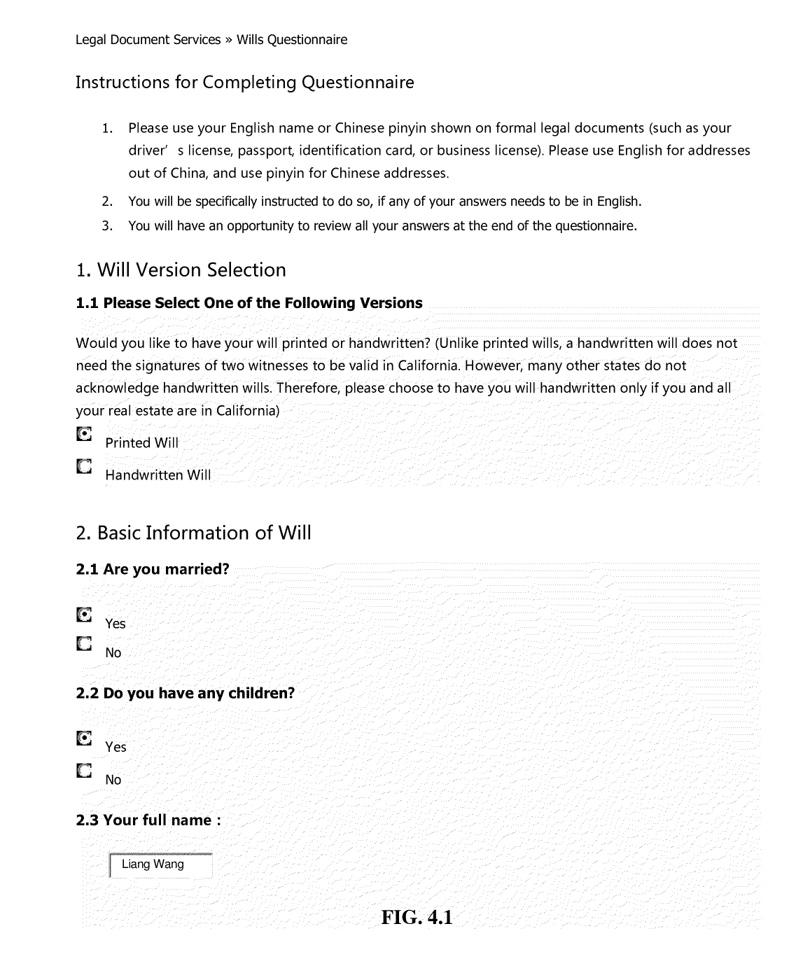

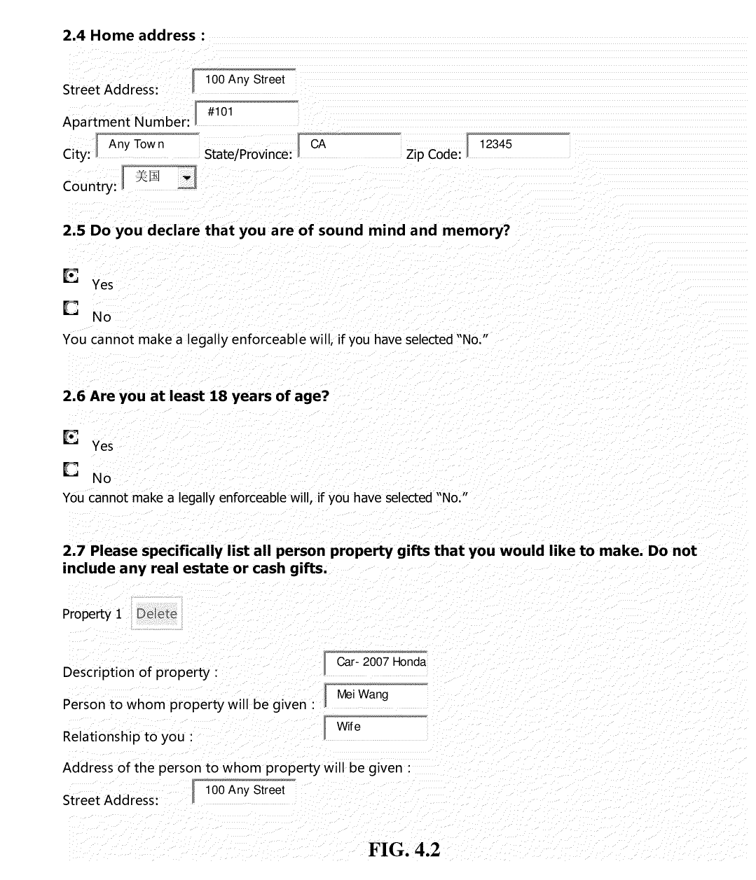

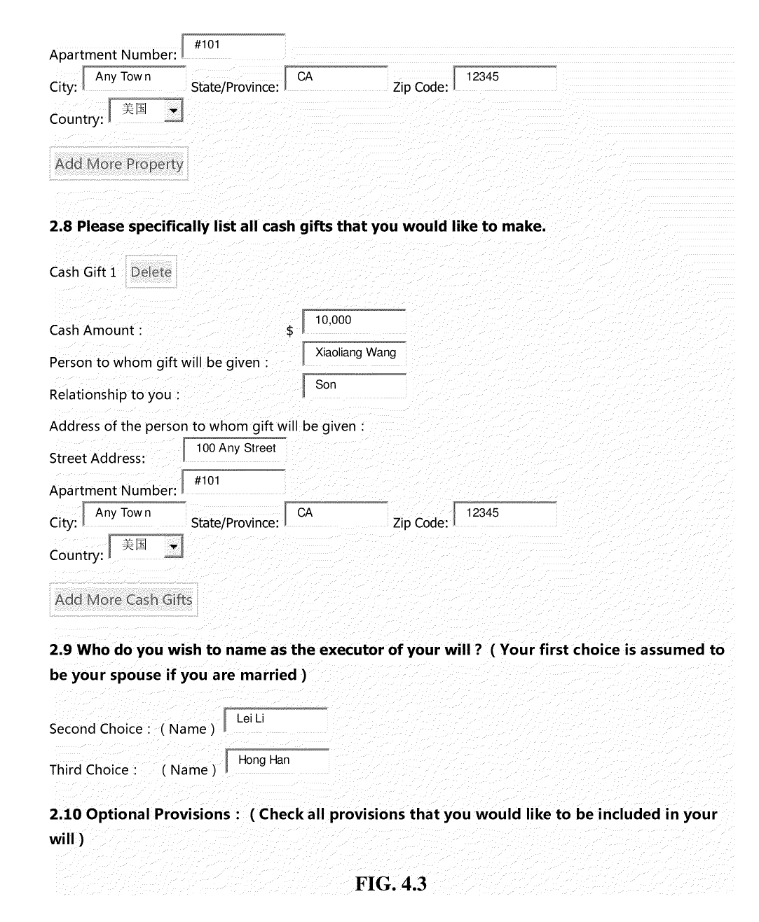

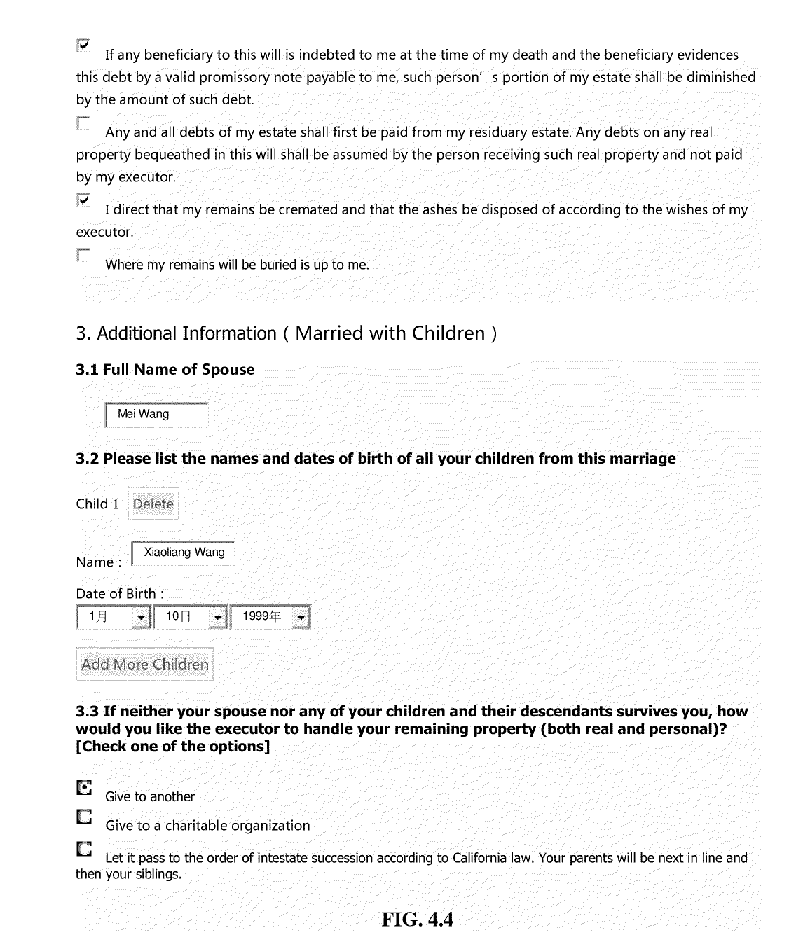

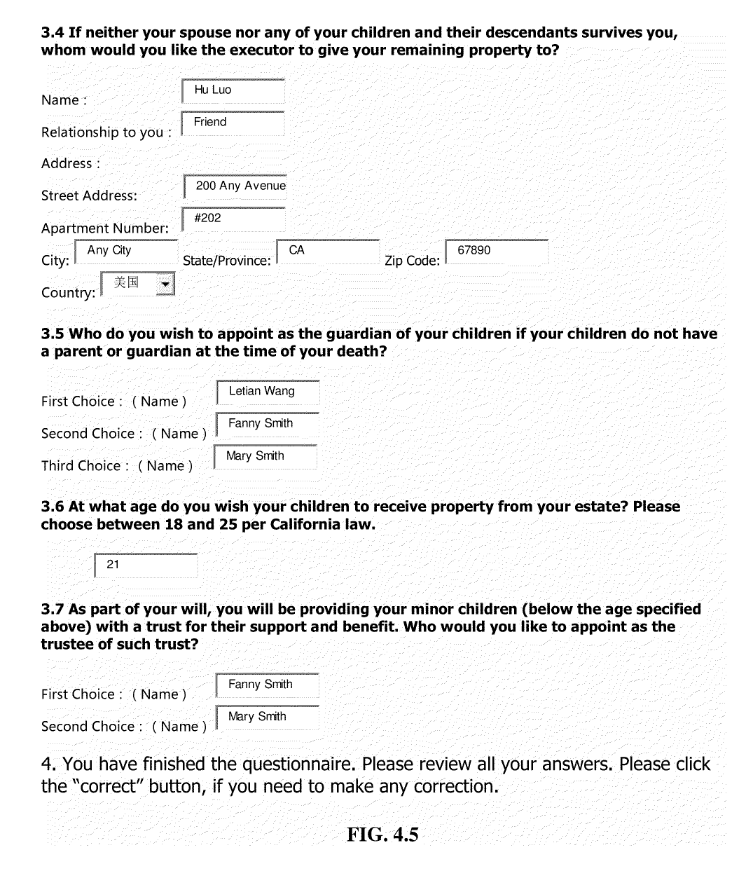

Now turn to a detailed example of a specific questionnaire designed for the purposes of creating a will for a California resident who does not have strong English language skills but reads and understands simplified Chinese. As illustrated in FIG. 3, the questionnaire is written in simplified Chinese. FIG. 4 is the English translation of FIG. 3. The questions included in the questionnaire are presented in the following in English.

1.1 Are you married?

1.2 Do you have any children?

1.3 Your full name:

1.4 Your home address:

1.5 Do you declare that you are of sound mind and memory?

1.6 Are you an adult (at least 18 years of age)?

1.7 Please specifically list all personal property gifts (do not include real estate or cash) that you would like to make.

1.8 Please specifically list all cash gifts that you would like to make.

1.9 Who do you wish to name as the executor of your will?

1.10 Optional provisions: Check the box(es) next to the provision(s) that you would like to be included in your will

2.1 If married, what is the full name of your spouse?

2.2 Please list the full name and date of birth for each of your children from this or any previous marriage or adopted:

2.3 If neither your spouse nor your children or their descendants survive you, how would you like the executor handle your remaining property (both real and personal)? [Check one of the options]

2.4 If neither your spouse nor your children or their descendants survive you, to whom would you like the remaining property be given?

2.5 Who do you wish to appoint as the guardian of each of your children if he/she does not have a parent or guardian at the time of your death?

2.6 At what age (between 18 and 25 according to California law) do you wish your children to receive property from your estate?

2.7 As part of your will, you will be providing your minor children (below the age specified above) with a trust for their benefit. Who would you like to appoint as the trustee of this trust?

The questions listed above or the order or format thereof is not exclusive for a questionnaire designed for creating a will. The questions are presented here to show that an online questionnaire designed according to the present invention is capable of soliciting sufficient information for the creation of a legal document such as a will. As illustrated by Question 2.6, state-specific questions may be included to serve users of different states. It is the duty of the legal staff of a provider to ascertain that a legal document that is created for a client or user is consistent with federal and state law.

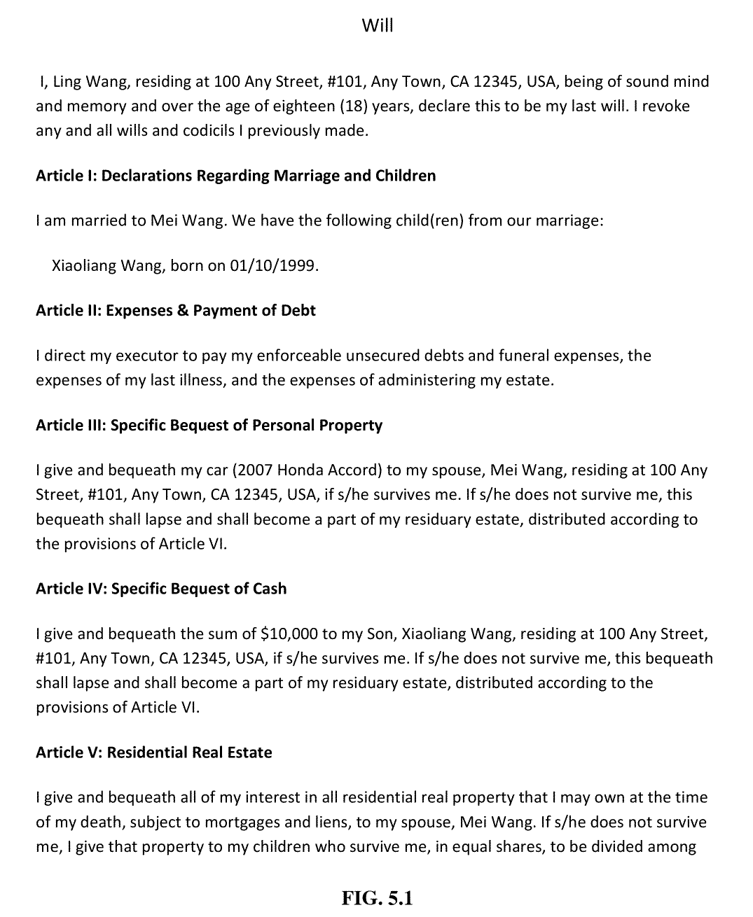

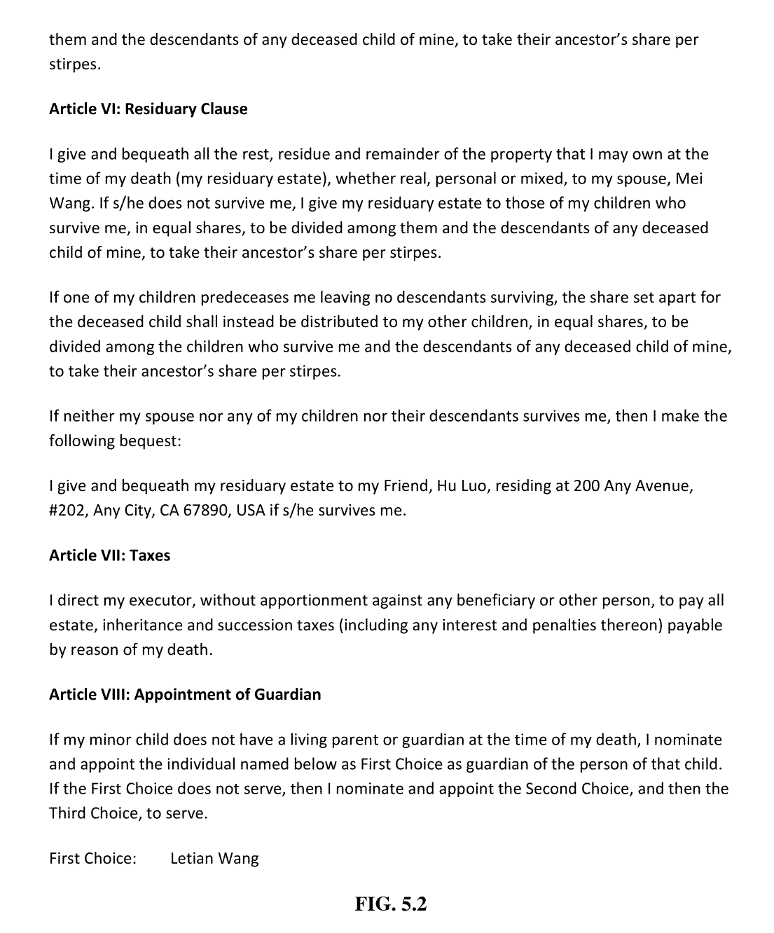

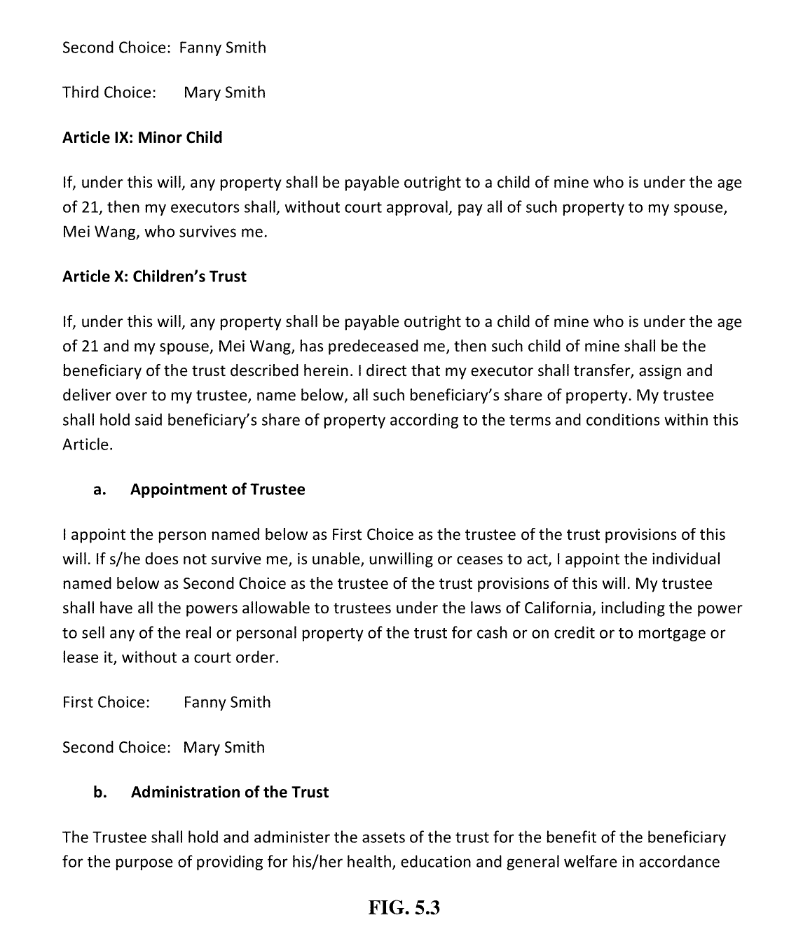

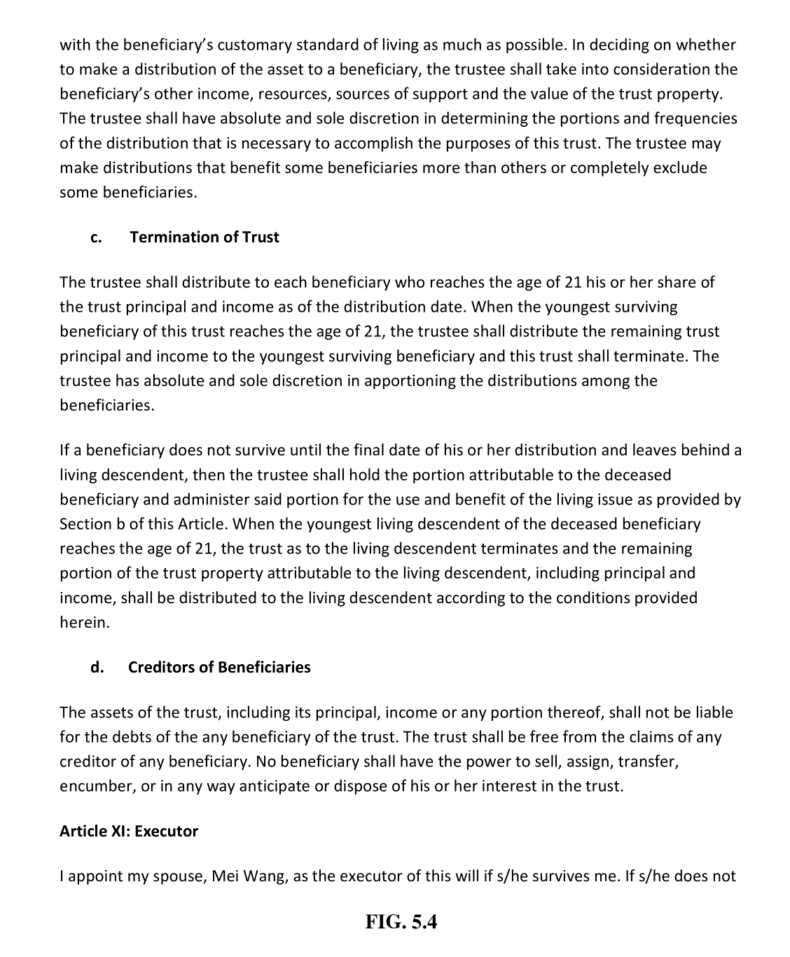

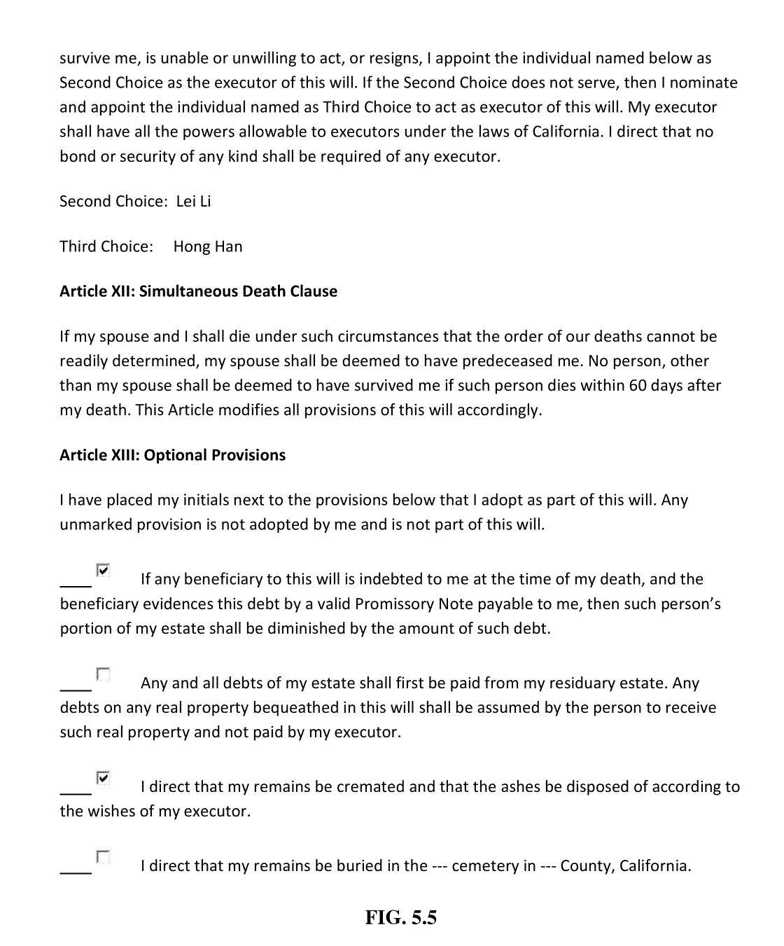

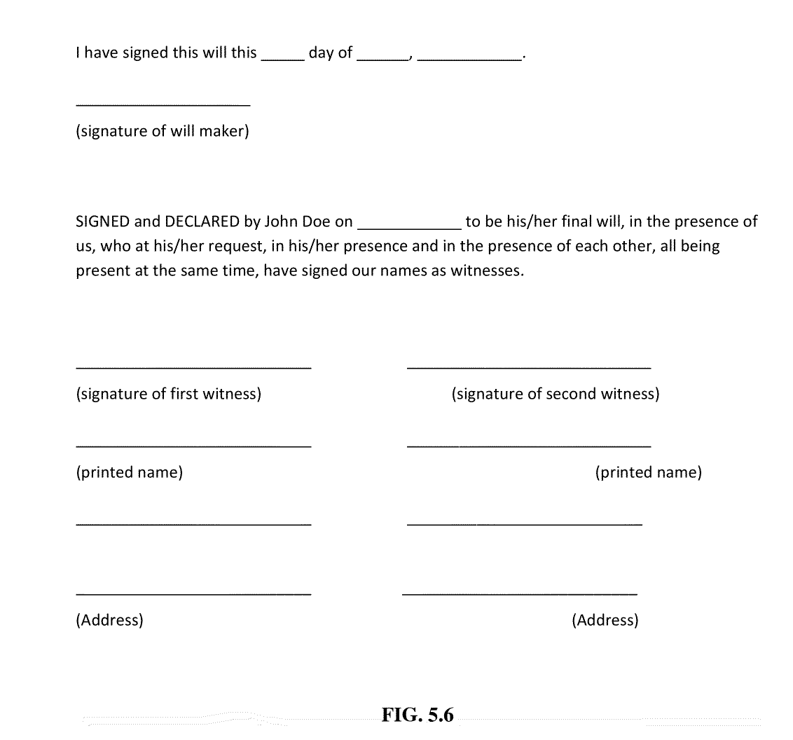

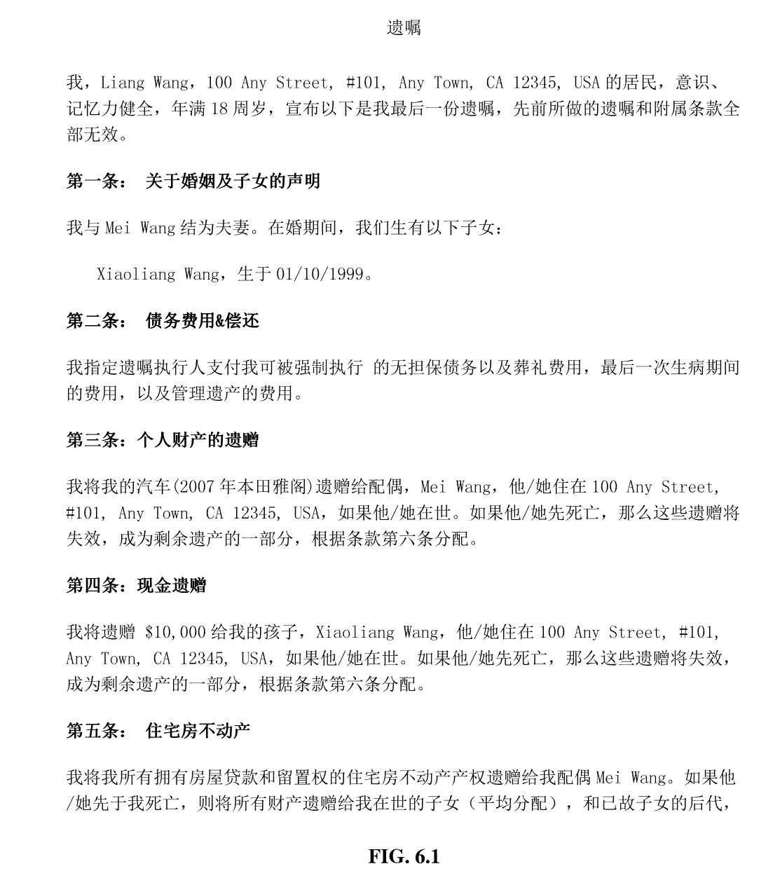

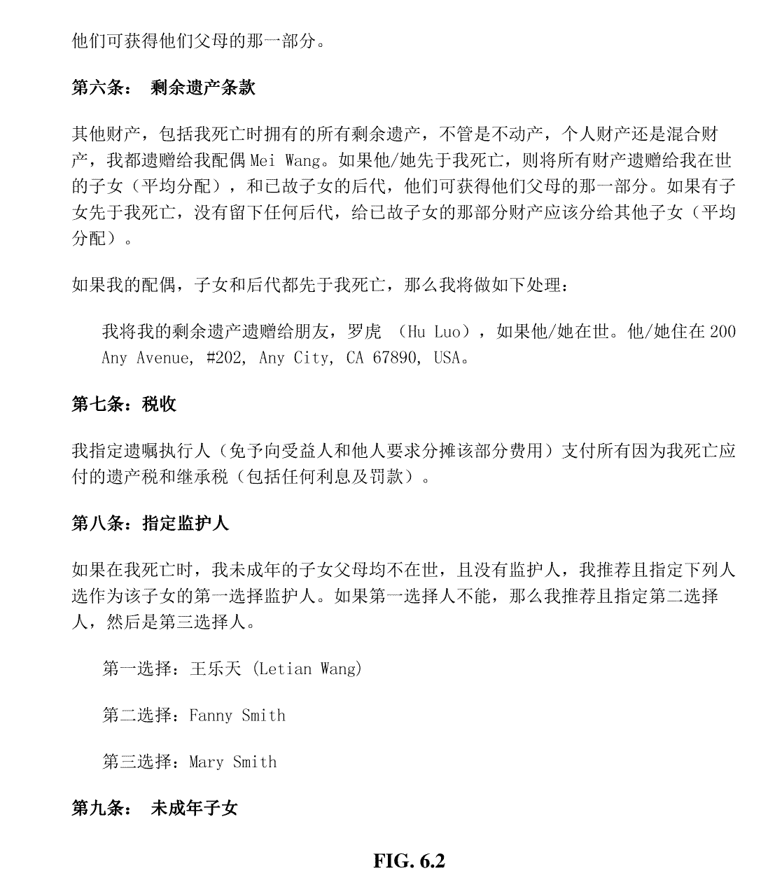

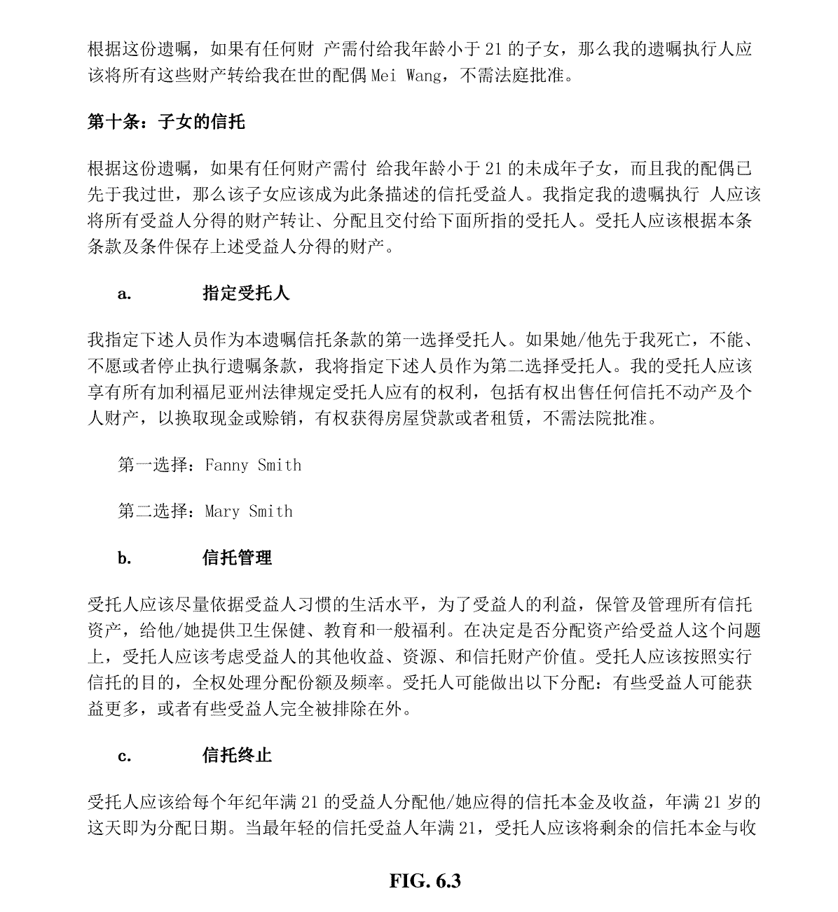

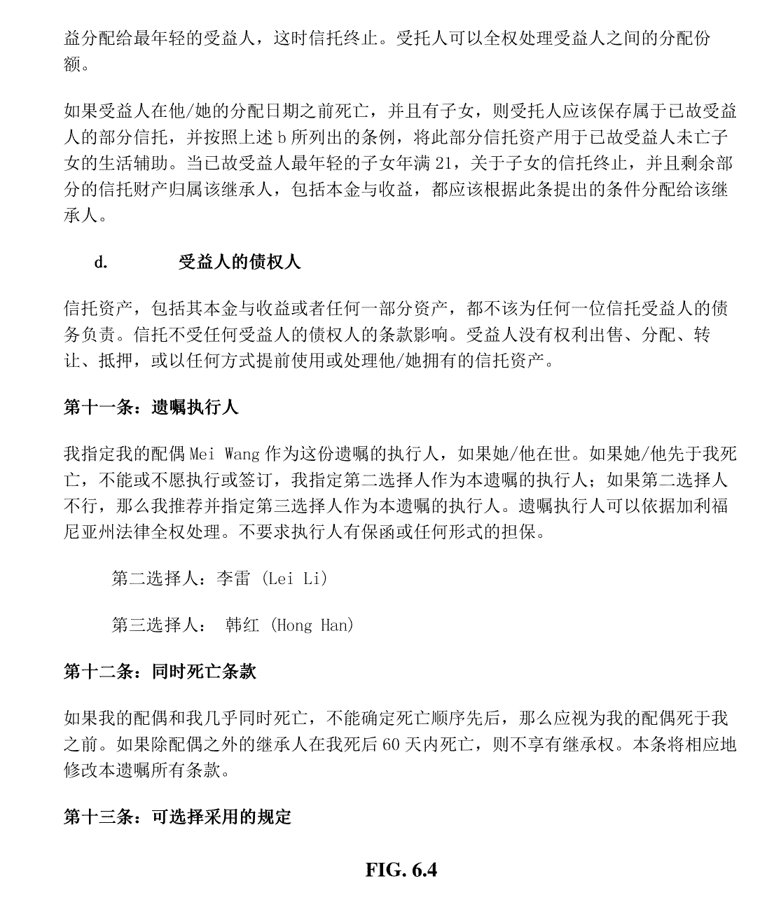

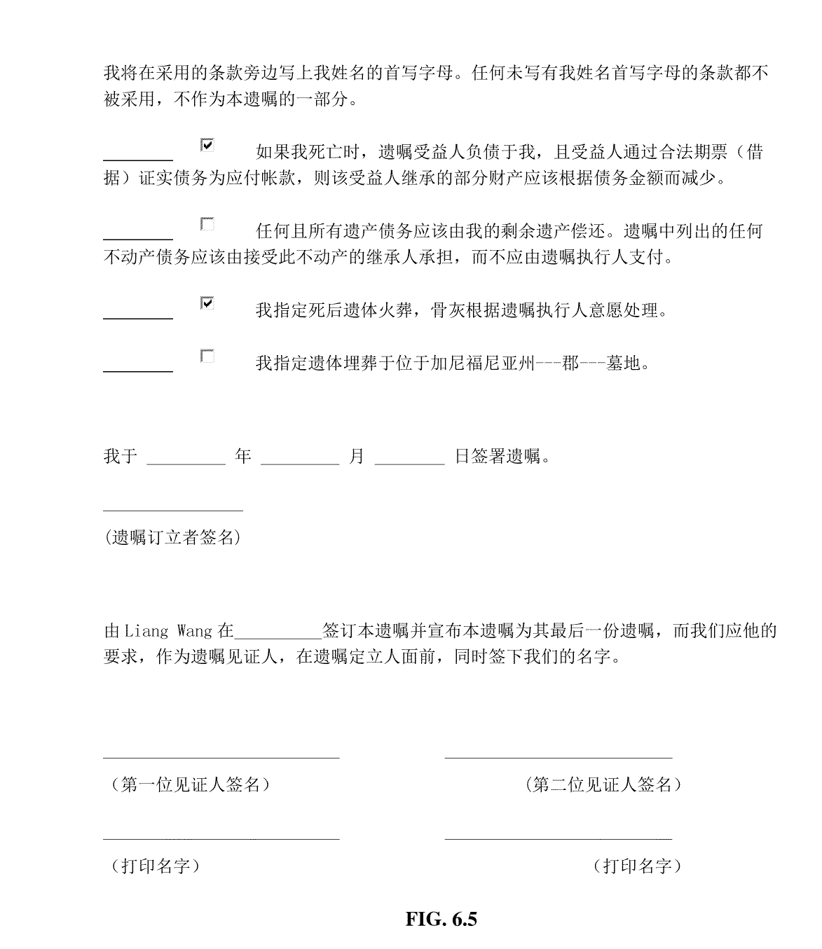

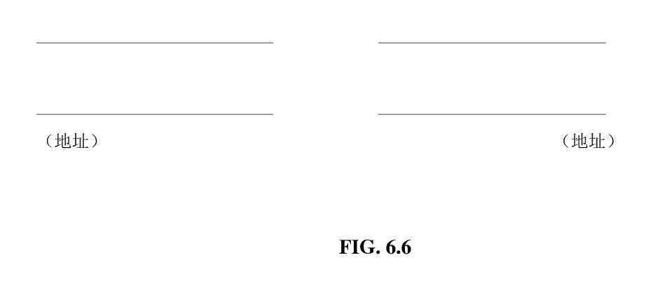

Finally, FIG. 5 illustrates a sample will that is created based on information retrieved from the user-input included in the questionnaire illustrated in FIG. 3. The Chinese copy of the sample will is illustrated in FIG. 6.

What is claimed is:

1. A method of providing English or bilingual legal documents in an online setting to users lacking English language skills, comprising:
Creating and maintaining a database of questionnaires, wherein all questionnaires of said database of questionnaires are written in a language other than English and are designed to solicit information from a user that lacks English language skills but reads and understands well said language other than English for the purpose of creating a legal document desired by said user;
Creating and maintaining a database of uncustomized legal documents, wherein each uncustomized legal document of said database of uncustomized legal documents is written in English, corresponds to a questionnaire of said database of questionnaires, and contains at least one Tillable field that lacks at least one piece of information that is needed to complete said uncustomized legal document;
Displaying at a host web portal, via an electronic display apparatus, to said user a questionnaire taken from said database of questionnaires, wherein said questionnaire instructs said user to answer all questions included in said questionnaire;
Collecting and storing user input retrieved from said questionnaire answered by said user, translating said user input into English, and identifying the uncustomized legal document corresponding to said questionnaire;
Creating a customized legal document by customizing said uncustomized legal document using information retrieved from the English translation of said questionnaire, said customized legal document being translated to said language other than English where said user requests bilingual legal documents through said questionnaire; and
Delivering electronically said customized legal document to said user, a copy of said customized legal document in said language other than English being delivered as well where said user requests bilingual legal documents through said questionnaire.

2. The method of claim 1 wherein each questionnaire of said database of questionnaires contains at least one question adapted to elicit information usable to populate a Tillable field in an uncustomized legal document.

3. The method of claim 1 or 2 wherein said user is allowed to edit and confirm the accuracy of said user input before said user input is collected and stored.

4. The method of any of claims 1 to 3 wherein said customized legal document is electronically delivered to said user through email.

5. The method of any of claims 1 to 3 wherein said customized legal document is electronically delivered to said user by making said customized legal document downloadable by the user via said host web portal.

6. The method of any of claims 1 to 5 wherein said language other than English is Chinese.
